(19) United States
(12) Patent Application Publication
(10) Pub. No.: US 2007/0074419 A1
(43) Pub. Date: Apr. 5, 2007

(54) Multi-layer dryer seal

(76) Inventor: David Starrett, Greer, SC (US)

Correspondence Address: J.M. ROBERTSON INTELLECTUAL PROPERTY, 233 SOUTH PINE STREET, SPARTANBURG, SC, 29302, US

(21) Appl. No.: 11/327,138

(22) Filed: Jan. 6, 2006

Related U.S. Application Data
(60) Provisional application No. 60/722,617, filed on Sep. 30, 2005.

(51) Int. Cl. F26B 25/00; F26B 11/02

(52) U.S. Cl. 34/242; 34/601

(57) ABSTRACT

A dryer seal of substantially simplified construction which utilizes a folded construction of cooperating fibrous layers that are held in adjoined needled relation across their contacting surfaces. The needled layers are folded over and seamed inboard of the folded edge to yield a first leg and a second leg projecting away from the folded edge. The first leg is of substantially greater length than the second leg.

### CROSS-REFERENCE TO RELATED APPLICATIONS

This application claims benefit of and priority from provisional application 60/722,617 having a filing date of Sep. 30, 2005 the contents of which are hereby incorporated by reference in their entirety as if fully set forth herein.

### TECHNICAL FIELD

This invention relates to a dryer seal and more particularly to a dryer seal of simplified construction incorporating an arrangement of fibrous material forming a multi-layer sealing element of folded and seamed construction incorporating an exterior layer of low friction wool-component felt and an interior layer of polymeric felt. The layers are secured substantially across their interfaces by needing.

### BACKGROUND OF THE INVENTION

Automatic clothes dryers typically include a housing (also known as a bulkhead) and a rotating drum supported within the housing. It is known to use seal elements in the form of rings of felt which may be disposed between the housing and the drum so as to bear against the drum as it rotates. The use of a sealing element is desirable to prevent air leakage between the drum and the clothes dryer cabinet which could detrimentally affect the air flow system of the dryer. It is known to utilize seals in the form of ring structures incorporating a folded over exterior layer such as wool or wool blend nonwoven material with a spacer material such as polyester or polyester blend material held within the folded over exterior. The legs projecting outwardly from the folded edge form a sealing contacting relation with the rotating drum. Past structures have typically used substantially discrete exterior layers and spacer layers held together in the desired configuration by sewn seams.

### SUMMARY OF THE INVENTION

This invention provides advantages and alternatives over the prior art by providing a dryer seal of substantially simplified construction which utilizes a folded construction of cooperating fibrous layers that are held in adjoined needled relation across their contacting surfaces. The needled layers are folded over and seamed inboard of the folded edge to yield a first leg and a second leg projecting away from the folded edge. The first leg is of substantially greater length than the second leg. Each of the legs incorporates an upper or outer layer of wool or wool blend felt and a lower or inner layer of polymer or polymer blend felt such as polyester or the like. The layers forming the legs remain needled together across their interfacial surfaces.

### BRIEF DESCRIPTION OF THE DRAWINGS

The following drawings which are incorporated in and which constitute a part of this specification illustrate an exemplary embodiment of the present invention and, together with the general description above and the detailed description set forth below, serve to explain the principles of the invention wherein:

FIG. 1 is a perspective view of an exemplary clothes dryer with the rotating drum and seal illustrated in phantom;

FIG. 2 is an exploded cut-away view of a seal according to the present invention with the seal mounted around a bulkhead flange;

FIG. 3 is a cross section of the seal in folded, seamed configuration.

While the invention has been generally described above and will hereinafter be described in connection with certain potentially preferred embodiments and procedures, it is to be understood and appreciated that in no event is the invention to be limited to such illustrated and described embodiments and procedures. On the contrary, it is intended that the present invention shall extend to all alternatives and modifications as may embrace the broad principles of this invention within the true spirit and scope thereof.

### DESCRIPTION

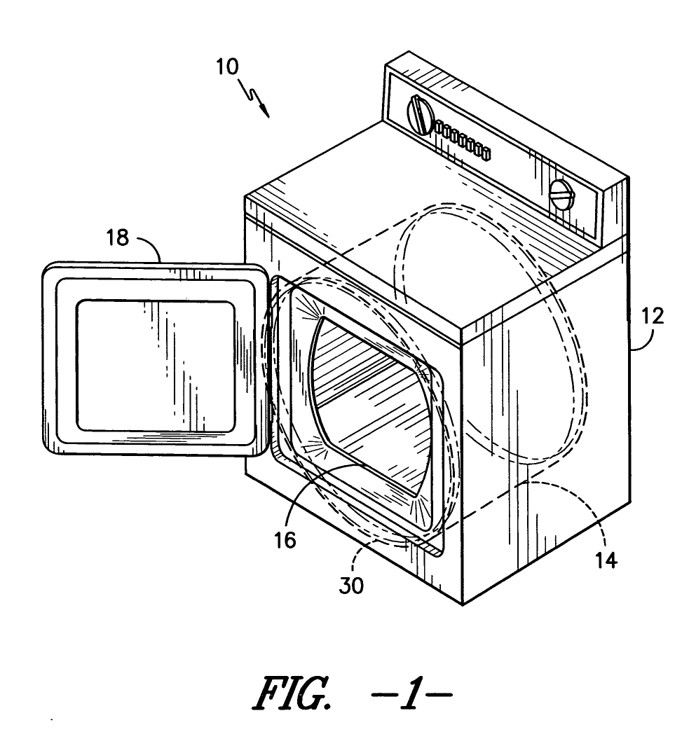

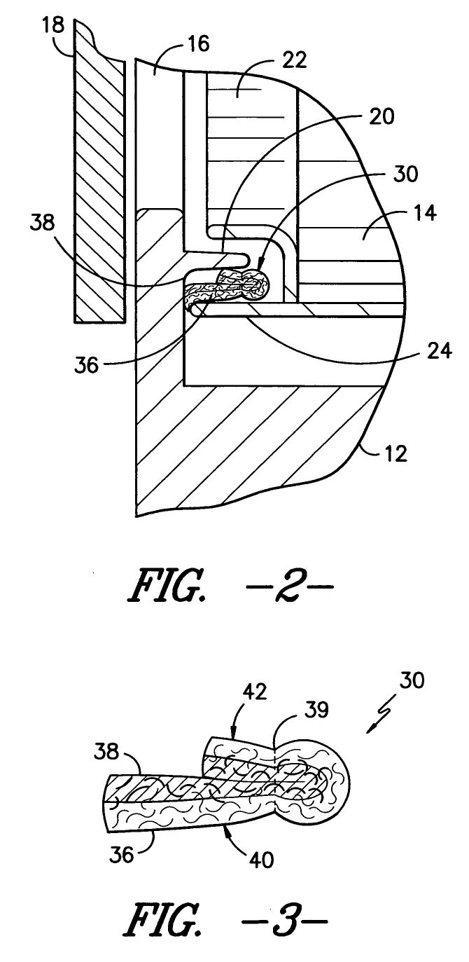

Reference will now be made to the various drawings wherein to the extent possible like reference numerals are utilized to designate corresponding components throughout the various views. In FIGS. 1 and 2, there is illustrated a dryer 10 including a cabinet body 12 housing a heated rotating drum 14. As illustrated, the cabinet body includes a door opening 16 for loading clothing articles into the mouth of the drum 14. The door opening 16 may be closed by means of a door 18.

As will be well known to those of skill in the art, the cabinet body 12 typically includes a bulkhead flange 20 (FIG. 1A) surrounding the door opening and projecting into the interior of the cabinet body. The bulkhead flange 20 is disposed generally around a reduced diameter drum opening 22. An outer wall portion 24 of the drum is disposed in surrounding relation to the flange or ring 20.

As shown, a seal 30 is disposed around the bulkhead flange 20 between the outer wall portion 24 and the bulkhead flange 20. As will be appreciated by those of skill in the art, dryers are typically vacuum systems. In operation the seal 30 prevents the draw of cool (non-heated) air from around the drum. With this flow path blocked, air is drawn more efficiently into the drum from a heated element area for use and eventual vent discharge.

The seal 30 includes a fibrous exterior layer 36 and an internal fibrous interior support layer 38. The exterior layer and the interior support layer are secured together across their interfacial surfaces such as by needling or the like such that fibers from each layer are mechanically joined to one another across the interface. As the dryer is operated the drum 14 may experience a degree of oscillation up and down.

The joined exterior layer 36 and interior support layer 38 are folded over and seamed at a position inboard of the folded edge such as by a chain or lock stitch seam 39. Such a folding and seaming operation forms a first leg 40 and a second leg 42 projecting generally away from the folded edge. The first leg 40 is of substantially greater length than the second leg 42. Each of the legs includes the layered structure of the exterior layer 36 and the interior support layer 38 such that the exterior layer 36 and the interior support layer 38 each extend substantially continuously from the terminal end of the first leg to the terminal end of the second leg. The legs may flair out or compress as required to adjust for this up and down oscillation and thereby maintain contacting sealing relation with the moving drum.

As will be appreciated, the dryer seal 30 is preferably of substantially circular construction. According to one potentially preferred practice the dryer seal 30 is formed by adjoining the opposing ends of an elongate sealing structure having a general cross-section as shown in FIG. 3 by use of end to end stitching or other attachment means such as ultrasonic welding and the like as may be known to those of skill in the art.

According to an exemplary formation practice, the exterior layer 36 is a needle punched nonwoven textile material formed from entangled fibers of wool or wool blend material such as wool and polyester or other synthetic fiber. Recycled grey wool material may be particularly desirable. In such a construction, the wool provides a degree of natural lubricity which may aid in avoiding premature damage. The interior support layer 38 is preferably a needle punched nonwoven of polyester. In one exemplary construction this interior support layer is needle punched polyester. The exterior layer 36 and the interior support layer 38 are preferably mechanically joined across their interfacial surfaces such as by interlayer needling or the like such that fibers from each of the layers extend across the interface in entangling relating with fibers of the opposing layer.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A dryer seal comprising an elongate multi-layer structure wherein said elongate multi-layer structure comprises a strip of fibrous material folded upon itself to establish a folded perimeter edge, a first leg portion projecting away from said folded perimeter edge, a second leg portion projecting away from said folded perimeter edge, wherein the first leg portion is of greater length than the second leg portion and wherein the strip of fibrous material comprises a fibrous wool constituent exterior layer in needled adjoined relation to a fibrous polyester constituent interior layer such that each of the leg portions includes the fibrous wool constituent exterior layer in needled adjoined relation to the fibrous polyester constituent interior layer and wherein a single attachment seam extends at an inboard location substantially parallel to said folded perimeter edge.

2. The invention as recited in claim 1, wherein said single attachment seam comprises a chain stitch seam construction.

3. The invention as recited in claim 1, wherein said single attachment seam comprises a lock stitch seam construction.
